(19) United States
(12) Patent Application Publication
(10) Pub. No.: US 2003/0184207 A1
(43) Pub. Date: Oct. 2, 2003

(54) Sound suppressing structure and method thereof

(75) Inventors: Kuo-Hsien Chuang, Yangmei Jen (TW); Kuo-Cheng Chen, Yangmei Jen (TW); Chin-Kuo Wang, Yangmei Jen (TW)

Correspondence Address: Webb Ziesenheim Logsdon, Orkin & Hanson, P.C., 700 Koppers Building, 436 Seventh Avenue, Pittsburgh, PA, 15219-1818, US

(73) Assignee: Chunghwa Picture Tubes Ltd.

(21) Appl. No.: 10/177,392

(22) Filed: Jun. 21, 2002

(30) Foreign Application Priority Data
Mar. 26, 2002 (TW) 91105959

(51) Int. Cl. H01J 29/80

(52) U.S. Cl. 313/402

(57) ABSTRACT

A sound suppressing structure is provided. The sound suppressing structure applied to a cathode-ray tube (CRT) having a frame, an inner shield, and at least one fixing element for fixing the frame and the inner shield, includes a rib portion formed on one of the frame and the inner shield, wherein the rib portion contacts with the other one of the frame and the inner shield for reducing a contacting area between the frame and the inner shield, so as to suppress a noise produced by vibrations of the frame and the inner shield.

### FIELD OF THE INVENTION

This invention relates to a sound suppressing structure and a method thereof, and more particularly to a sound suppressing structure and method thereof to be applied to an inner shield in a cathode-ray tube (CRT).

### BACKGROUND OF THE INVENTION

Generally, a deviation of the falling point of the electron beam and an uneven appearance of the screen are caused by the terrestrial magnetism and the external magnetic field. Hence a CRT has an inner shield disposed therein, which provides a magnetic shielding effect in order to avoid the electron beam in the CRT being affected by the terrestrial magnetism and the external magnetic field. For positioning the electron beam on the screen at correct positions, the internal magnetic field inside the inner shield should be controlled to be zero so that an external alternating current must be provided to generate an induced magnetic field inside the inner shield to decay the external magnetic field. Consequently, the induced magnetic field will neutralize the external magnetic field owing to the external alternating current so that there is no inner magnetic field in the inner shield thereafter. But, during the process of demagnetization, the inner shield is easy to vibrate owing to the magnetic force, especially the contacting portion between the chassis of the inner shield and the frame. When the amplitude of vibration is too large or the fixing way is not perfect, a hit might be produced therebetween, so that a noise will be appeared thereafter.

FIG. 1 shows the structure of the conventional inner shield in a CRT. As shown in FIG. 1, a frame 11 and an inner shield 12 are fixed together by a clip 13. During the process of demagnetization, because of the influence of the magnetic force, a vibration will be produced between the frame 11 and the inner shield 12, and thus a noise will be sequentially appeared at the contacting portion 14 between the frame 11 and the inner shield 12.

Thus how to eliminate the noise produced by the vibration between the frame 11 and the inner shield 12 during the process of demagnetization is an emphasis for one skilled in the CRT.

### SUMMARY OF THE INVENTION

It is an object of the present invention to provide a sound suppressing apparatus formed on the inner shield for reducing the noise produced during the process of demagnetization.

It is another object of the present invention to provide a sound suppressing apparatus to suppress the noise through reducing the contacting area between the frame and the inner shield in the CRT during the process of demagnetization.

According to an aspect of the present invention, a sound suppressing structure used with a cathode-ray tube (CRT) having a frame, an inner shield, and at least one fixing element for fixing the frame and the inner shield, includes a rib portion formed on one of the frame and the inner shield, wherein the rib portion contacts with the other one of the frame and the inner shield for reducing a contacting area between the frame and the inner shield, so as to suppress a noise produced by vibrations of the frame and the inner shield.

Preferably, the rib portion has a triangular cross-section.

Preferably, the rib portion has a trapezoid cross-section.

Preferably, the rib portion has an arcuate cross-section.

Preferably, the fixing element is a flexible piece.

Preferably, the fixing element is a bolt.

Preferably, the inner shield is made of a material of a high magnetic permeability.

Preferably, the inner shield is made by a drawing method.

Preferably, the inner shield is made by a bending method.

Preferably, the rib portion is formed by a pressing method.

In accordance with another aspect of the present invention, a sound-suppressing apparatus used with a CRT (Cathode Ray Tube) having a frame, an inner shield, and a fixing element for fixing the inner shield to the frame, includes a contact-area-reducing device formed on one of the frame and the inner shield for contacting with the other one of the frame and the inner shield for reducing a contact area therebetween.

Preferably, the contact-area-reducing device is a rib portion.

Preferably, the contact-area-reducing device is a curved portion.

In accordance with another aspect of the present invention, a sound suppressing structure used with a CRT (Cathode Ray Tube) having a frame, an inner shield, and at least one fixing element for fixing the frame and the inner shield, wherein the inner shield is curved with a specific angle from a surface of the frame for reducing a contacting area between the frame and the inner shield, so as to suppress a noise produced by vibrations of the frame and the inner shield.

Preferably, the at least one fixing element is a flexible piece.

Preferably, the at least one fixing element is a bolt.

Preferably, the inner shield is made of a material of a high magnetic permeability.

Preferably, the inner shield is made by a drawing method.

Preferably, the inner shield is made by a bending method.

Preferably, the specific angle is less than ten degrees.

In accordance with further aspect of the present invention, a method for suppressing a sound for a CRT (Cathode Ray Tube) having a frame, an inner shield, and a fixing element for fixing the frame and the inner shield includes steps of forming a contact-area portion on one of the frame and the inner shield for reducing a contacting area therebetween, so as to suppress a noise produced by vibrations of the frame and the inner shield.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a structural view showing a conventional inner shield in a CRT;

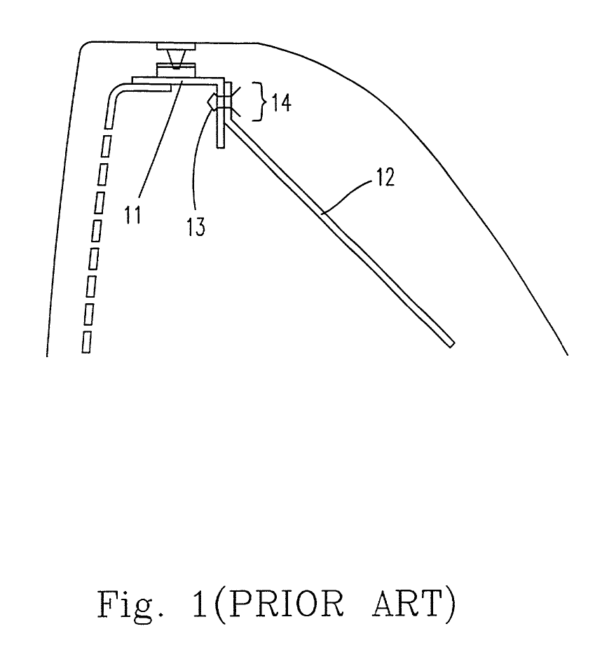

FIG. 2 is a structural view of a first preferred embodiment according to the present invention; and

FIG. 3 is a structural view of a second preferred embodiment according to the present invention.

### DETAILED DESCRIPTION OF THE PREFERRED EMBODIMENT

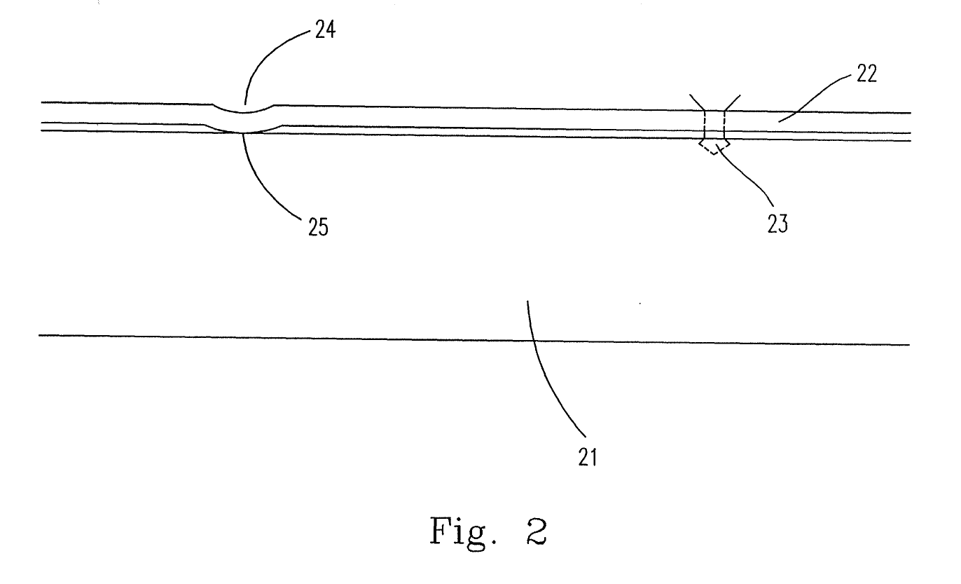

FIG. 2 shows the structural view of a first preferred embodiment according to the present invention. As shown in FIG. 2, a sound suppressing structure includes a frame 21, an inner shield 22, a fixing element 23, and a rib portion 24. The rib portion 24 is formed on the inner shield 22, and the inner shield 22 and the frame 21 are fixed together by the fixing element 23. The rib portion 24 formed on the inner shield 22 is contacted with the frame 21 to form a contacting portion 25 between the frame 21 and the inner shield 22, wherein the contacting portion 25 is a contacting area of the rib portion 24 and the frame 21. Consequently, comparing with the conventional contacting portion between the frame and the inner shield in the CRT, the contacting area of the contacting portion 25 in the present invention is reduced significantly. And because of the reduction of the contacting area, as described above, the noise produced by the vibration between the frame 21 and the inner shield 22 can be suppressed. Otherwise, the reinforced rib portion 24 has another function of increasing the structural strength of the inner shield except suppressing the appearance of the noise.

Certainly, the rib portion 24 will not be limited in a specific shape. Because the manufacturing method is usually a punching method, the cross-section of the rib portion 24 is usually designed as triangular, trapezoid, and arcuate shapes which are easier for pressing and punching. The width of the rib portion 24 should be properly controlled in a range from 2 to 8 mm. The depth of the rib portion 24 should also be controlled in a rang from 0.5 to 4 mm for matching up the fixing condition of the inner shield 22 so as to prevent a breakdown caused by an excess of processing or a malposition while assembling. The fixing element 23 used to fix the frame 21 and the inner shield 22 is usually a clip or a bolt. The fixing element 23 is penetrated through the frame 21 and the inner shield 22 for fixing therebetween. Generally, the inner shield 22 is made of a material of a high magnetic permeability for improving the magnetic shielding effect thereof, and the inner shield 22 can be made by a drawing method or a bending method.

Because the contacting area between the frame 21 and the inner shield 22 is changed into the contacting portion 25 between the rib portion 24 and the frame 21, the noise caused by the vibration between the frame 21 and the inner shield 22 can be reduced significantly during the process of demagnetization. Consequently, the purpose of suppressing the noise is achieved thereby.

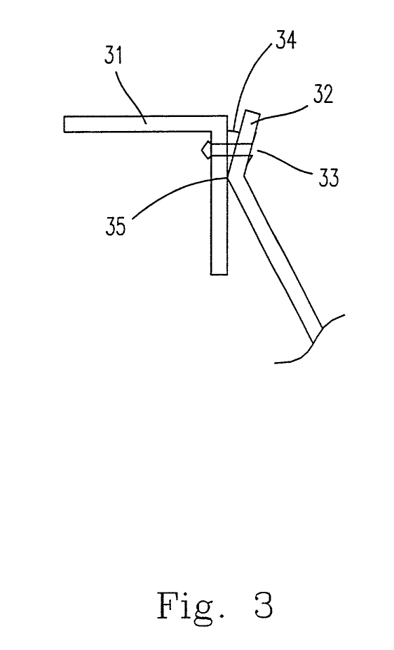

FIG. 3 shows a structural view in a second preferred embodiment according to the present invention. As show in FIG. 3, a sound suppressing structure includes a frame 31, an inner shield 32, and a fixing element 33. The frame 31 and the inner shield 32 are fixed together by the fixing element 33. The inner shield 32 is curved with a specific angle 34 from the surface of the frame 31 for reducing a contacting portion 35 between the frame 31 and the inner shield 32, so as to suppress a noise produced by vibrations of the frame 31 and the inner shield 32 during the process of demagnetization.

The fixing element 33 can be a clip or a bolt. Generally, the inner shield 32 is made of a material of a high magnetic permeability for improving the magnetism shielding effect, and the inner shield 32 can be made by a drawing method or a bending method. The specific angle 34 should be controlled to be less than ten degrees for avoiding the interval between the inner shield 32 and the frame 31 being too far, so as to cause the electron beam to escape from therebetween and appear a second reflection.

In view of the aforesaid, the sound suppressing structure of the present invention absolutely can suppress the noise produced by vibrations of the frame and the inner shield during the process of demagnetization of the CRT by reducing the contacting area between the frame and the inner shield. Besides, the reinforced rib portion can increase the structural strength of the inner shield and also suppress the noise. Furthermore, the cost of fabricating the structure in the present invention will not be increased which is compared with the prior art. Thus, the present invention is advanced and novel and is practical for the industries.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A sound suppressing structure used with a CRT (Cathode Ray Tube) having a frame, an inner shield, and at least one fixing element for fixing said frame and said inner shield, comprising:
a rib portion formed on one of said frame and said inner shield, wherein said rib portion contacts with the other one of said frame and said inner shield for reducing a contacting area between said frame and said inner shield, so as to suppress a noise produced by vibrations of said frame and said inner shield.

2. The structure according to claim 1 wherein said rib portion has a triangular cross-section.

3. The structure according to claim 1 wherein said rib portion has a trapezoid cross-section.

4. The structure according to claim 1 wherein said rib portion has an arcuate cross-section.

5. The structure according to claim 1 wherein said fixing element is a clip.

6. The structure according to claim 1 wherein said fixing element is a bolt.

7. The structure according to claim 1 wherein said inner shield is made of a material of a high magnetic permeability.

8. The structure according to claim 1 wherein said inner shield is made by a drawing method.

9. The structure according to claim 1 wherein said inner shield is made by a bending method.

10. The structure according to claim 1 wherein said rib portion is formed by a pressing method.

11. A sound-suppressing apparatus used with a CRT (Cathode Ray Tube) having a frame, an inner shield, and a fixing element for fixing said inner shield to said frame, comprising:
a contact-area-reducing device formed on one of said frame and said inner shield for contacting with the other one of said frame and said inner shield for reducing a contact area therebetween.

12. An apparatus according to claim 11 wherein said contact-area-reducing device is a rib portion.

13. An apparatus according to claim 11 wherein said contact-area-reducing device is a curved portion.

14. A sound suppressing structure used with a CRT (Cathode Ray Tube) having a frame, an inner shield, and at least one fixing element for fixing said frame and said inner shield, wherein said inner shield is curved with a specific angle from a surface of said frame for reducing a contacting area between said frame and said inner shield, so as to suppress a noise produced by vibrations of said frame and said inner shield.

15. The structure according to claim 14 wherein said at least one fixing element is a clip.

16. The structure according to claim 14 wherein said at least one fixing element is a bolt.

17. The structure according to claim 14 wherein said inner shield is made of a material of a high magnetic permeability.

18. The structure according to claim 14 wherein said inner shield is made by a drawing method.

19. The structure according to claim 14 wherein said inner shield is made by a bending method.

20. The structure according to claim 14 wherein said specific angle is less than ten degrees.

21. A method for suppressing a sound for a CRT (Cathode Ray Tube) including a frame, an inner shield, and a fixing element for fixing said frame and said inner shield together, comprising steps of:
forming a contact-area portion on one of said frame and said inner shield for reducing a contacting area therebetween, so as to suppress a noise produced by vibrations of said frame and said inner shield.
